(19) United States
(12) Patent Application Publication
(10) Pub. No.: US 2002/0159548 A1
(43) Pub. Date: Oct. 31, 2002

(54) Reducing noise in a communication system

(76) Inventors: Gregory Morgan Evans, Raleigh, NC (US); Michael Ryan Avett, Cary, NC (US); Mathew Wayne Baker, Portsmouth, VA (US); Keith Alan Deweese, Asheville, NC (US)

Correspondence Address: BROWDY AND NEIMARK, P.L.L.C., 624 NINTH STREET, NW, SUITE 300, WASHINGTON, DC, 20001-5303, US

(21) Appl. No.: 09/845,250

(22) Filed: May 1, 2001

(30) Foreign Application Priority Data
Apr. 30, 2001 (IL) 142884

(51) Int. Cl. H04L 25/08; H04L 1/00; H03D 1/04; H03D 1/06; H04B 1/10; H03K 5/01; H03K 6/04; H04B 15/00

(52) U.S. Cl. 375/346; 375/285

(57) ABSTRACT

A line balance correction device adapted to correct longitudinal balance of a copper pair carrying xDSL signals and to produce a cancellation signal for reducing at least one of common-mode noise and differential signal imbalance. The device may be installed at any segment of a copper pair wiring of an xDSL transmission system that requires correction of longitudinal balance. The device is adapted to be connected in parallel to the copper pair and to a local ground and includes a controller and circuitry for correcting longitudinal balance. At least one variable resistor is connected to each wire of the copper pair. The resistance of each such variable resistor being independently controlled by the controller for matching resistance of signals carried over a corresponding wire of the copper pair to the local ground.

### BACKGROUND OF THE INVENTION

Communication systems that employ various digital subscriber line (DSL) formats, generally indicated as xDSL, typically utilize copper pairs such as unshielded twisted pairs (UTPs) or shielded twisted pairs (STPs) as transmission lines for communicating information between a central office (CO) or a service provider and subscriber units. Typically, an xDSL transmission environment that uses copper pairs has various impairments, one of which is longitudinal balance over the full applicable frequency range utilized by xDSL which is typically non-optimal.

Non-optimal longitudinal balance typically enables ingress of electromagnetic radiation from radio waves and adjacent copper pairs thereby reducing effective bandwidth and range over which xDSL transmission can be used. Additionally, non-optimal longitudinal balance may induce electromagnetic interference (EMI) that may have adverse effects on xDSL communication in large deployments of xDSL transmission systems.

Some aspects of related technologies and prior art are described in the following publications:

The Communications Handbook, CRC Press & IEEE Press, 1997, Editor-in-Chief Jerry D. Gibson, Chapter 34, pp. 450-479;

U.S. Pat. No. 5,887,032 to Cioffi which describes an apparatus or system for data communication that removes crosstalk interference (e.g., NEXT interference) from received signals on a given line by adaptively estimating the crosstalk interference induced by certain other of the lines having interfering transmissions and by canceling the crosstalk interference using the estimated crosstalk interference from the certain other of the lines;

U.S. Pat. No. 5,970,088 to Chen which describes a reverse channel near-end crosstalk (NEXT) canceller bank that is implemented within an MDSL modem pool and is used to cancel NEXT;

U.S. Pat. No. 6,078,613 to Bingel which describes a system and method for bridging multiple communication devices to a single communication connection;

U.S. Pat. No. 6,157,680 to Betts et al which describes an audio distortion canceller method and apparatus that is configured to adaptively cancel the nonlinear low frequency audible harmonic distortion caused by a device, such as a conventional telephone, connected to the communication line;

U.S. Pat. No. 6,173,021 to Bingel et al which describes a method and apparatus for reducing interference in a twisted wire pair transmission system; and

U.S. patent application Ser. No. 09/324,842 to Evans et al which describes a system employing xDSL spectrum relocation.

The disclosures of all references mentioned above and throughout the present specification are hereby incorporated herein by reference.

### SUMMARY OF THE INVENTION

The present invention seeks to provide a method and apparatus for correcting longitudinal balance of copper pairs carrying xDSL signals and for reducing or removing common mode noise and common mode data-service signals in xDSL communication. Each such apparatus may preferably be installed at each segment of a copper pair wiring of an xDSL transmission system that requires correction of longitudinal balance.

Further objects and features of the invention will become apparent to those skilled in the art, from the following description and the accompanying drawings.

There is thus provided in accordance with a preferred embodiment of the present invention a line balance correction device for correcting longitudinal balance of a copper pair, the device is adapted to be connected in parallel to the copper pair and to a local ground, and including a controller, and at least one variable resistor for connecting to each wire of the copper pair, wherein the resistance of each at least one variable resistor is independently controlled by the controller for matching, at least up to an acceptable resistance difference level, resistance of signals carried over a corresponding wire of the copper pair to the local ground.

Additionally, the device may also include at least one current source for connecting to each wire of the copper pair, each at least one current source being independently controlled by the controller for providing at least one cancellation signal for reducing at least one of the following: common-mode noise; and differential signal imbalance.

Further additionally, the device may also include at least one voltage detector operatively associated with the controller for enabling the controller to compute at least one of the following: a line imbalance, and common-mode noise versus differential signal imbalance. The at least one voltage detector may preferably include at least one of the following: at least one root-mean-square (RMS) voltage detector, at least one peak voltage detector, and an xDSL signal type detector.

Still additionally, the device may also include a band-pass filter operatively associated with the at least one voltage detector, the band-pass filter being programmable throughout a frequency band of an xDSL transmission and operative to output band-limit signals to the at least one voltage detector.

Preferably, the at least one voltage detector provides to the controller at least one of the following: an RMS value of a signal carried on a Tip wire of the copper pair, an RMS value of a signal carried on a Ring wire of the copper pair, a peak value of a signal carried on a Tip wire of the copper pair, and a peak value of a signal carried on a Ring wire of the copper pair.

Further preferably, the at least one RMS voltage detector includes at least one RMS voltage detector for each wire of the copper pair and the at least one peak voltage detector includes at least one peak voltage detector for each wire of the copper pair.

The device may alternatively or additionally include a programmable switch operatively controlled by the controller for enabling the at least one voltage detector to selectively detect one of the following: an RMS voltage of a signal carried on a Tip wire of the copper pair, an RMS voltage of a signal carried on a Ring wire of the copper pair, a peak voltage of a signal carried on a Tip wire of the copper pair, and a peak voltage of a signal carried on a Ring wire of the copper pair.

Yet additionally, the device may also include a power supply operative to supply electric power to active components of the device.

Further, the device may also include an xDSL signal type detector operatively associated with the controller for enabling the controller to compute common-mode noise versus differential signal imbalance. The xDSL detector is preferably operative to provide at least one differential-mode component for enabling the controller to compute at least one peak voltage-to-RMS voltage ratio for analyzing common-mode noise versus differential signal imbalance.

Preferably, the device corrects longitudinal balance of a copper pair carrying one of the following: unidirectional signals, and bi-directional signals.

Further in accordance with a preferred embodiment of the present invention there is provided a line balance correction device for correcting longitudinal balance of a copper pair, the device being adapted to be connected in parallel to the copper pair and to a local ground, the device including a controller, and at least one current source for connecting to each wire of the copper pair, each at least one current source being independently controlled by the controller for providing at least one cancellation signal for reducing at least one of the following: common-mode noise; and differential signal imbalance.

There is also provided in accordance with a preferred embodiment of the present invention a line balance correction device for correcting longitudinal balance of a copper pair, the device being connected in parallel to the copper pair and to a local ground, the device including a controller, and at least one voltage detector operatively associated with the controller for enabling the controller to compute at least one of the following: a line imbalance, and common-mode noise versus differential signal imbalance.

The line balance correction device may be comprised in an xDSL transmission system including an xDSL Transceiver Unit central office (xTU-C), an xDSL Transceiver Unit remote unit (xTU-R), and a copper pair operatively associating the xTU-C with the xTU-R.

Further in accordance with a preferred embodiment of the present invention there is provided a method for correcting longitudinal balance of a copper pair, the method including sensing resistance of each wire of the copper pair, and independently controlling the resistance of each wire of the copper pair for matching, at least up to an acceptable resistance difference level, resistance of signals carried over a corresponding wire of the copper pair to a local ground.

Yet further in accordance with a preferred embodiment of the present invention there is provided a method for correcting longitudinal balance of a copper pair, the method including computing at least one of the following: common-mode noise on the copper pair, and differential signal imbalance on the copper pair, and providing at least one cancellation signal for respectively reducing at least one of the following: the common-mode noise, and the differential signal imbalance.

Still further in accordance with a preferred embodiment of the present invention there is provided a method for correcting longitudinal balance of a copper pair, the method including detecting, for each wire of the copper pair, at least one of the following: a RMS voltage, and a peak voltage, and using at least one of the RMS voltage and the peak voltage to compute at least one of the following: a line imbalance, and common-mode noise versus differential signal imbalance.

### BRIEF DESCRIPTION OF THE DRAWINGS

The present invention will be understood and appreciated more fully from the following detailed description, taken in conjunction with the drawings in which:

FIG. 1 is a simplified block diagram illustration of a preferred implementation of an xDSL transmission system constructed and operative in accordance with a preferred embodiment of the present invention;

FIG. 2 is a simplified block diagram illustration of a preferred implementation of a line balance correction device in the system of FIG. 1, the line balance correction device being constructed and operative in accordance with a preferred embodiment of the present invention;

FIG. 3 is a simplified block diagram illustration of another preferred implementation of a line balance correction device in the system of FIG. 1, the line balance correction device being constructed and operative in accordance with a preferred embodiment of the present invention;

FIG. 4 is a simplified flowchart illustration of a preferred method of operation of the apparatus of FIGS. 1-3;

FIG. 5 is a simplified flowchart illustration of another preferred method of operation of the apparatus of FIGS. 1-3; and

FIG. 6 is a simplified flowchart illustration of yet another preferred method of operation of the apparatus of FIGS. 1-3.

### DETAILED DESCRIPTION OF A PREFERRED EMBODIMENT

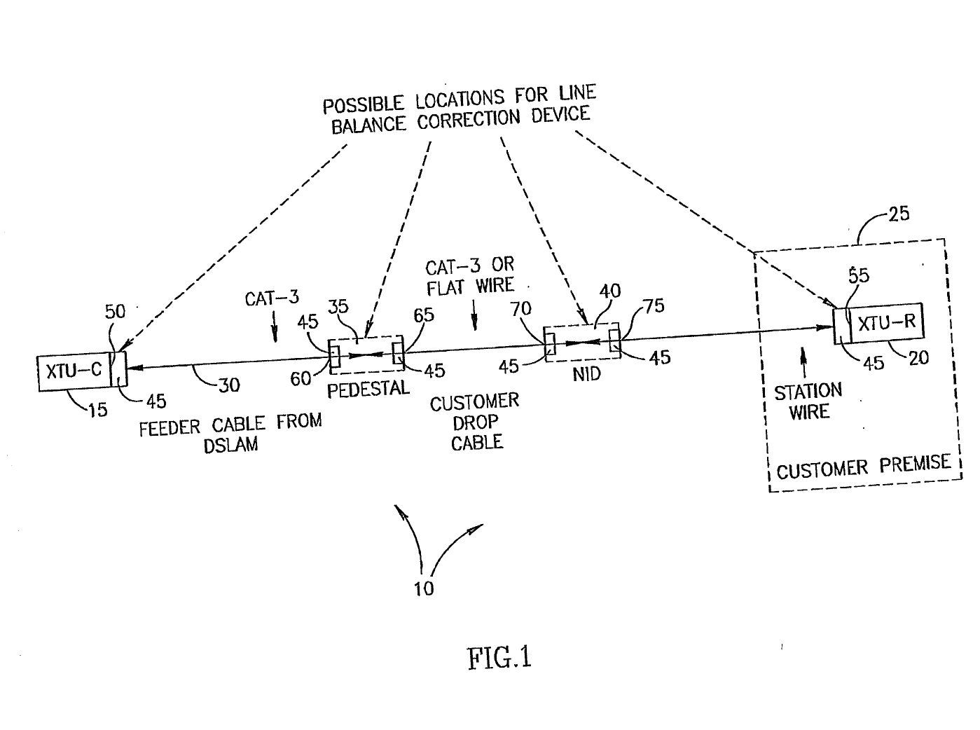

Reference is now made to FIG. 1 which is a simplified block diagram illustration of a preferred implementation of an xDSL transmission system 10 constructed and operative in accordance with a preferred embodiment of the present invention.

The xDSL transmission system 10 preferably includes an xDSL Transceiver Unit central office (xTU-C) 15 that is typically comprised in a digital subscriber line access multiplexer (DSLAM) (not shown) at a central office (CO) side. The xTU-C 15 is preferably in one-way or two-way communication with an xDSL Transceiver Unit remote unit (xTU-R) 20 at customer premises 25 via a copper pair 30 typically comprising a twisted pair of wires such as Category-3 (CAT-3) UTP wires, or unshielded non-twisted wires (Flat Wires).

Throughout the specification and claims the term “xDSL” is used to indicate a selected one of the well-known family of digital-subscriber-line (DSL) formats that can be used for communication in the system 10, such format including any standardized DSL format or proprietary DSL format. Examples of xDSL formats include the following: an SDSL (Symmetric DSL) format; an HDSL (High speed DSL) format; an ADSL (Asymmetric DSL) format; a VDSL (Very high speed DSL) format; an SHDSL (Symmetric HDSL) format; a RADSL (Rate Adaptive DSL) format; and an MDSL (Medium speed DSL) format.

Typically, xDSL transmissions are fed to the copper pair 30 by the XTU-C 15 and by the XTU-R 20. Depending on a configuration of the system 10, additional elements may be installed along the line from the XTU-C 15 to the XTU-R 20. Such elements may include, for example, a pedestal 35 that aggregates a plurality of copper pairs that carry xDSL transmissions to various customers, and a network interface device (NID) 40.

Typically, an xDSL transmission environment that uses copper pairs has various impairments, one of which is longitudinal balance over the full applicable frequency range utilized by xDSL which is typically non-optimal. In a preferred embodiment of the present invention a line balance correction device 45 is installed at each segment of the copper pair 30 wiring that requires correction of longitudinal balance in order to correct the longitudinal balance of the segment of the copper pair 30.

The term “longitudinal balance” is used throughout the specification and claims in accordance with a definition found, for example, in the web page “http://glossary.its.bldrdoc.gov/fs-1037/dir-021/ 3122.htm”, to refer to the electrical symmetry, with respect to ground, of the two wires of a pair, or alternatively, as an expression of the difference in impedance of the two sides of a circuit.

Non-optimal longitudinal balance typically enables ingress of electromagnetic radiation from radio waves and adjacent copper pairs thereby reducing effective bandwidth and range over which xDSL transmission can be used. Additionally, non-optimal longitudinal balance may induce electromagnetic interference (EMI) that may have adverse effects on xDSL communication in large deployments of xDSL transmission systems.

FIG. 1 shows potential locations for installation of line balance correction devices 45 in the xDSL transmission system 10. The potential locations may include, for example, the following: an input/output section 50 of the copper pair 30 at the xTU-C 15; an input/output section 55 of the copper pair 30 at the xTU-R 20; input/output sections 60 and 65 of the copper pair 30 at the pedestal 35; and input/output sections 70 and 75 of the copper pair 30 at the NID 40.

It is appreciated that line balance correction devices 45 need not necessarily be installed at all the locations mentioned above, but rather at those of the locations mentioned above in which non-optimal longitudinal balance is found. Non-optimal longitudinal balance may also be found at other locations (not shown) along the line between the xTU-C 15 and the xTU-R 20 in which case the line balance correction devices 45 may be installed at such locations.

When located at an input/output section of the copper pair 30 that is near any element of the system 10, line balance correction devices 45 installed at such a location may preferably be comprised in the element of the system 10. Thus, line balance correction devices 45 may preferably be comprised in any of the following elements: the xTU-C 15; the pedestal 35; the NID 40; and the xTU-R 20.

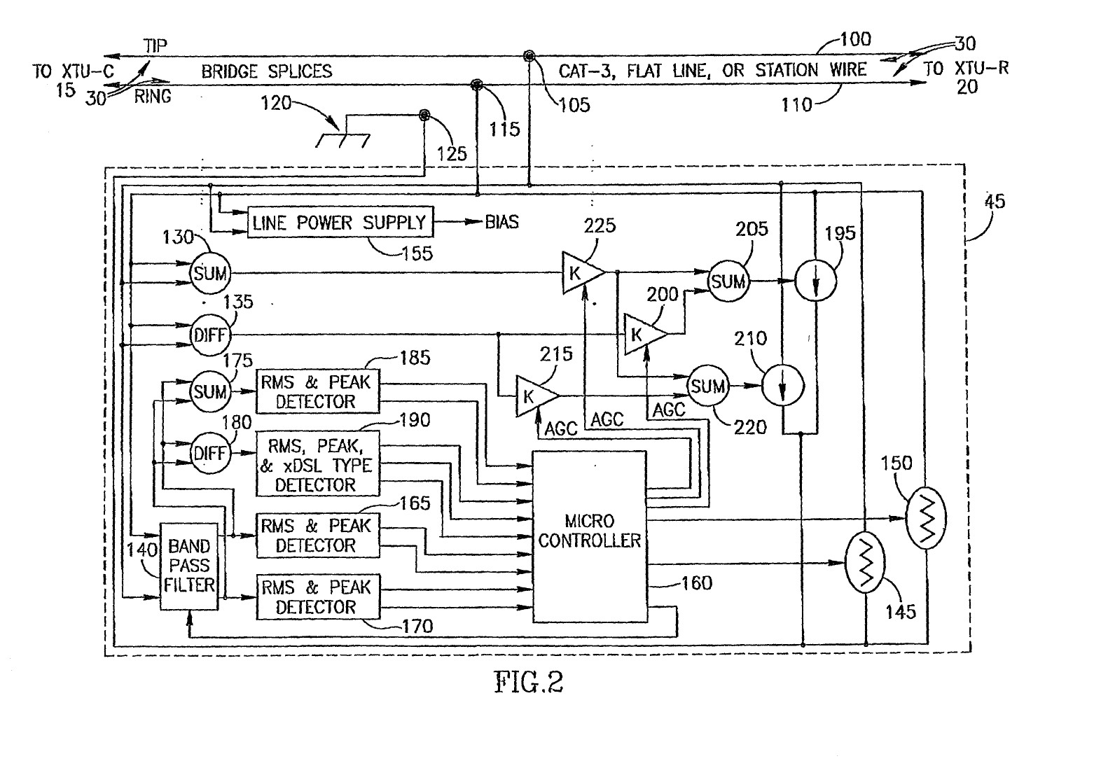

Reference is now made to FIG. 2 which is a simplified block diagram illustration of a preferred implementation of the line balance correction device 45 in the system 10 of FIG. 1, the line balance correction device 45 being constructed and operative in accordance with a preferred embodiment of the present invention.

Preferably, the line balance correction device 45 bridges onto a wire 100 of the copper pair 30 of FIG. 1 that typically carries a telephony “Tip” signal (Tip wire) via a first bridge splice 105, and onto a wire 110 of the copper pair 30 of FIG. 1 that typically carries a telephony “Ring” signal (Ring wire) via a second bridge splice 115. In addition to connecting in parallel to the copper pair 30 via the first bridge splice 105 and the second bridge splice 115, the line balance correction device 45 is also preferably connected to a local ground, indicated as 120, via a third bridge splice 125. It is appreciated that the copper pair 30 may be operative to carry one of the following: unidirectional signals; and bi-directional signals.

The term “local ground” is used throughout the specification and claims to include an earth ground or an added cable ground that may be deployed along with the copper pair 30.

Preferably, outputs of the bridge splices 105, 115 and 125 are fed to the line balance correction device 45. The outputs of the bridge splices 105 and 115 are preferably fed to the following elements: a summing amplifier 130; a differential amplifier 135; a band-pass filter 140; and variable resistors 145 and 150. The output of the bridge splice 125 is preferably connected to the variable resistors 145 and 150. It is appreciated that each of the variable resistors 145 and 150 may include either one variable resistor or a plurality of variable resistors.

In a case where the line balance correction device 45 cannot be locally powered, the line balance correction device 45 may also include a power supply unit 155 which is operative to draw electric power from the copper pair 30 via the bridge splices 105 and 115, and to convert the electric power drawn from the copper pair 30 to electric power suitable for powering active components of the device 45.

The band-pass filter 140 is preferably a programmable differential band-pass filter that is preferably adjusted and controlled by a controller 160, such as a conventional micro-controller commercially available from a plurality of vendors.

The band-pass filter 140 preferably outputs band-limits signals carried on the Tip wire 100 and the Ring wire 110 to a voltage detector 165 and a voltage detector 170 respectively. It is appreciated that each of the voltage detectors 165 and 170 may preferably include a root-mean-square (RMS) voltage detector and a peak voltage detector. The outputs of the voltage detectors 165 and 170 preferably include Tip RMS and peak voltages and Ring RMS and peak voltages respectively.

Preferably, the outputs of the voltage detectors 165 and 170 are provided to the controller 160. The controller 160 is preferably operative to compute a differential signal imbalance by assuming that external interfering signals, that cause line imbalance, are radiated equally onto the wires 100 and 110.

Differential signal imbalance is typically associated with differences between amplitudes of signals carried on the Tip wire 100 of the copper pair 30 and amplitudes of signals carried on the Ring wire 110 of the copper pair 30. Ideally, signals carried over the Tip wire 100 and signals carried over the Ring wire 110 have equal amplitudes and opposite polarity, but when the copper pair 30 does not have acceptable longitudinal balance, such as when external interfering signals are present, amplitudes of signals carried on the Tip wire 100 may be different from amplitudes of signals carried on the Ring wire 110 thereby resulting in differential mode noise components causing the differential signal imbalance.

Preferably, the controller 160 uses a computed differential signal imbalance to adjust the variable resistors 145 and 150 so as to match resistance of the signals carried over the wires 100 and 110 to the local ground 120, at least up to an acceptable difference level that may be for example about zero, thereby correcting the longitudinal balance of the copper pair 30.

The band-pass filter 140 also preferably provides a specific frequency range of a signal carried on the Tip wire 100 to a summing amplifier 175 and a specific frequency range of a signal carried on the Ring wire 110 to a differential amplifier 180.

The band-pass filter 140 also preferably outputs band-limits signals carried on the Tip wire 100 and the Ring wire 110 to a summing amplifier 175 and a differential amplifier 180 respectively. Preferably, the output of the summing amplifier 175 is fed to a voltage detector 185 that may preferably include a RMS voltage detector and a peak voltage detector. The output of the differential amplifier 180 is preferably fed to a voltage detector 190 that may also preferably include a RMS voltage detector and a peak voltage detector.

The voltage detector 185 preferably outputs to the controller 160 peak and RMS voltage readout values of signals carried over the wires 100 and 110 that are band limited by the band-pass filter 140. Similarly, The voltage detector 190 preferably outputs to the controller 160 peak, RMS and xDSL signal type voltage readout values of the signals carried over the wires 100 and 110 that are band limited by the band-pass filter 140.

The xDSL signal type voltage readout values of the signals carried over the wires 100 and 110 preferably include peak voltage values and RMS voltage values that are characteristic of a specific xDSL transmission transmitted over the copper pair 30 and preferably result in a peak voltage to RMS voltage ratio which is comparable to a predetermined theoretical ratio. The controller 160 preferably computes a local ratio of readout xDSL peak voltage to xDSL RMS voltage, compares the local ratio to the predetermined theoretical ratio and outputs feedback signals. The feedback signals are preferably provided to a high impedance current source 195 via an amplifier 200 and a summing amplifier 205 and to a high impedance current source 210 via an amplifier 215 and a summing amplifier 220. It is appreciated that each of the current sources 195 and 210 may include either one high impedance current source or a plurality of high impedance current sources.

The feedback signals outputted by the controller 160 are preferably employed to control the current sources 210 and 195 so as to enable the current sources 210 and 195 to inject to the wires 100 and 110 respectively at least one cancellation signal for reducing, or preferably canceling, differential signal imbalance.

The outputs of the bridge splices 105 and 115 that are fed to the summing amplifier 130 and the differential amplifier 135 preferably include non-band-passed common-mode signals having spectra throughout the whole xDSL band. The common-mode signals may include common-mode noise that may be generated due to external interfering signals radiating or coupling, typically equally, onto the Tip wire 100 and the Ring wire 110. Typically, the common-mode noise may be detected when common-mode signals carried on the wire 100 are added to common-mode signals carried on the wire 110 and the copper pair 30 has an acceptable line balance and negligible differential signal imbalance.

Due to the equal coupling of the external interfering signals onto the wires 100 and 110, subtraction of the signals carried on the wire 100 from the signals carried on the wire 110 provides a result which is free of common-mode noise components but includes differential signal imbalance components.

An example of a common-mode noise component may be a local AM radio station interfering signal that couples onto both the Tip wire 100 and the Ring wire 110 equally via electromagnetic interference (EMI). An example of a differential mode noise component may be an error signal or the differential signal imbalance.

Preferably, the differential amplifier 135 is operatively associated with the summing amplifier 205 via the amplifier 200, and the summing amplifier 130 is operatively associated with the summing amplifier 205 via an amplifier 225. The summing amplifier 130 and the controller 160 are preferably employed to monitor the common-mode signals with the controller 160 computing common-mode corrections required to be applied by the amplifiers 225 and 215 to the current sources 195 and 210 respectively via the summing amplifiers 205 and 220 respectively. The current sources 210 and 195 are preferably operative to inject to the wires 100 and 110 respectively at least one cancellation signal for reducing, or preferably canceling, the common-mode noise.

It is appreciated that the controller 160 may also use the outputs of the voltage detectors 165, 170, 185 and 190 to compute common-mode noise versus signal imbalance and peak-voltage-to-RMS-voltage ratios for analyzing common-mode noise versus differential signal imbalance.

The operation of the apparatus of FIGS. 1 and 2 is now briefly described. Preferably, upon installation of the xDSL transmission system 10, existence of line imbalance may be determined at various locations along the copper pair 30. Preferably, the line balance correction device 45 may be installed at a location in which line imbalance has actually been determined. At such location, the line balance correction device 45 is preferably connected in parallel to the copper pair 30 and to the local ground. Additionally, if a power source (not shown) is available at the location, the line balance correction device 45 may preferably be electrically connected to and fed by the power source. Alternatively, the line balance correction device 45 may employ power drawn from the copper pair 30 by utilizing the power supply 155.

Preferably, xDSL signals and telephony signals communicated over the copper pair 30 are fed into the line balance correction device 45. Band-passed signals are preferably fed to the voltage detectors 165, 170, 185 and 190, and non-band-passed signals are preferably fed to the summing amplifier 130 and the differential amplifier 135. Both band-passed signals and non-band-passed signals may be processed by the controller 160.

The controller 160 preferably adjusts the variable resistors 145 and 150 for matching, at least up to an acceptable resistance difference level that may be, for example, about zero, resistance of signals carried over a corresponding wire of the copper pair 30 to the local ground. Additionally, the controller 160 preferably controls the current sources 195 and 210 independently for providing at least one cancellation signal for reducing, or preferably canceling, at least one of the following: common-mode noise; and differential signal imbalance.

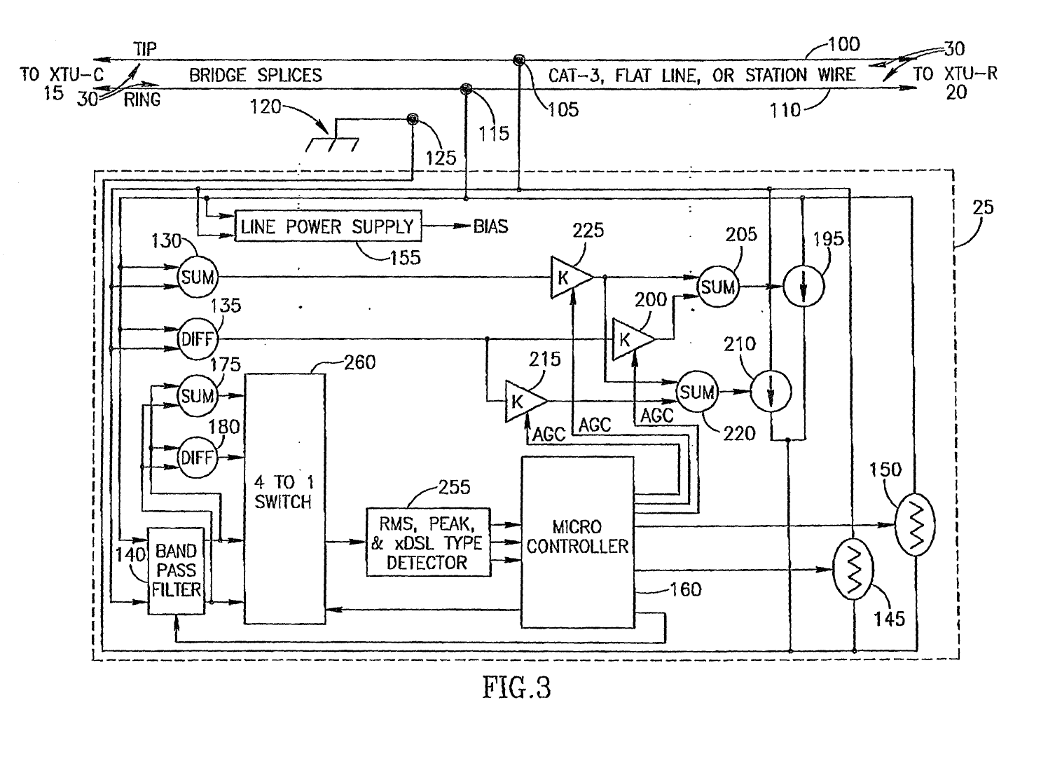

Reference is now made to FIG. 3 which is a simplified block diagram illustration of another preferred implementation of a line balance correction device 250 that may replace the line balance correction device 45 in the system 10 of FIG. 1, the line balance correction device 250 being constructed and operative in accordance with a preferred embodiment of the present invention.

The line balance correction device 250 is preferably similar to the line balance correction device 45 of FIG. 2 except that the voltage detectors 165, 170, 185 and 190 are replaced by a single voltage detector 255 that is operatively associated with the band-pass filter 140, the summing amplifier 175 and the differential amplifier 180 via a programmable switch 260.

The switch 260 is preferably controlled by the controller 160 to select a type of signals whose voltages are to be detected by the voltage detector 255 when the controller 160 computes a correction value for correcting a line imbalance. The type of values outputted by the voltage detector 255 to the controller 160 include peak, RMS and xDSL signal type voltage readout values of signals carried over the wires 100 and 110 that are band limited by the band-pass filter 140.

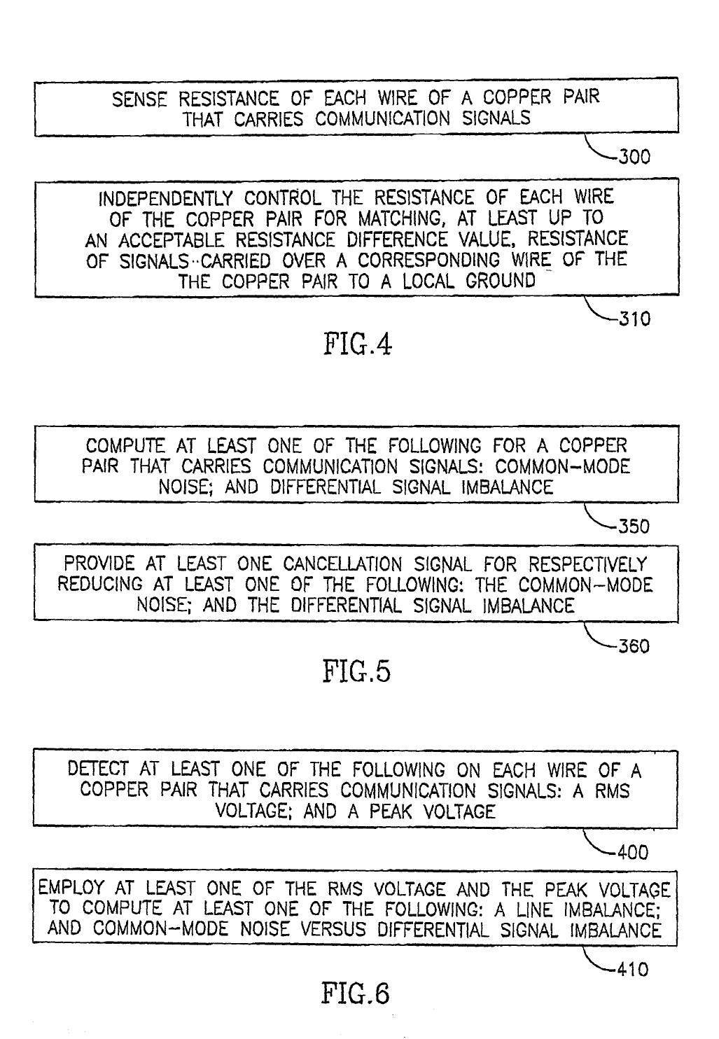

Reference is now made to FIG. 4 which is a simplified flowchart illustration of a preferred method of operation of the apparatus of FIGS. 1-3.

Preferably, resistance of each wire of a copper pair that carries communication signals is sensed (step 300). Then, the resistance of each wire of the copper pair is independently controlled for matching, at least up to an acceptable resistance difference level, resistance of signals carried over a corresponding wire of the copper pair to a local ground thereby correcting longitudinal balance of the copper pair (step 310).

Reference is now made to FIG. 5 which is a simplified flowchart illustration of another preferred method of operation of the apparatus of FIGS. 1-3.

Preferably, at least one of the following is computed for a copper pair that carries communication signals: common-mode noise; and differential signal imbalance (step 350). Then, at least one cancellation signal is provided for respectively reducing, or preferably canceling, at least one of the following: the common-mode noise; and the differential signal imbalance (step 360).

Reference is now made to FIG. 6 which is a simplified flowchart illustration of yet another preferred method of operation of the apparatus of FIGS. 1-3.

Preferably, at least one of the following is detected on each wire of a copper pair that carries communication signals: a RMS voltage; and a peak voltage (step 400). Then, at least one of the RMS voltage and the peak voltage is preferably used to compute at least one of the following: a line imbalance; and common-mode noise versus differential signal imbalance (step 410).

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

It will be appreciated by persons skilled in the art that the present invention is not limited by what has been particularly shown and described herein above. Rather the scope of the invention is defined by the claims which follow:

What is claimed is:

1. A line balance correction device for correcting longitudinal balance of a copper pair, the device is adapted to be connected in parallel to the copper pair and to a local ground, and comprising:
a controller; and
at least one variable resistor for connecting to each wire of the copper pair, wherein the resistance of each said at least one variable resistor is independently controlled by said controller for matching, at least up to an acceptable resistance difference level, resistance of signals carried over a corresponding wire of the copper pair to the local ground.

2. The device of claim 1 and also comprising:
at least one current source for connecting to each wire of the copper pair, each said at least one current source being independently controlled by said controller for providing at least one cancellation signal for reducing at least one of the following: common-mode noise; and differential signal imbalance.

3. The device of claim 1 and also comprising:
at least one voltage detector operatively associated with said controller for enabling said controller to compute at least one of the following: a line imbalance; and common-mode noise versus differential signal imbalance.

4. The device of claim 2 and also comprising:
at least one voltage detector operatively associated with said controller for enabling said controller to compute at least one of the following: a line imbalance; and common-mode noise versus differential signal imbalance.

5. The device of claim 3 and wherein said at least one voltage detector comprises at least one of the following: at least one root-mean-square (RMS) voltage detector; at least one peak voltage detector; and an xDSL signal type detector.

6. The device of claim 3 and also comprising a band-pass filter operatively associated with said at least one voltage detector, the band-pass filter being programmable throughout a frequency band of an xDSL transmission and operative to output band-limit signals to said at least one voltage detector.

7. The device of claim 5 and wherein said at least one voltage detector provides to said controller at least one of the following: an RMS value of a signal carried on a Tip wire of the copper pair; an RMS value of a signal carried on a Ring wire of the copper pair; a peak value of a signal carried on a Tip wire of the copper pair; and a peak value of a signal carried on a Ring wire of the copper pair.

8. The device of claim 5 and wherein said at least one RMS voltage detector comprises at least one RMS voltage detector for each wire of the copper pair.

9. The device of claim 5 and wherein said at least one peak voltage detector comprises at least one peak voltage detector for each wire of the copper pair.

10. The device of claim 3 and also comprising a programmable switch operatively controlled by said controller for enabling said at least one voltage detector to selectively detect one of the following: an RMS voltage of a signal carried on a Tip wire of the copper pair; an RMS voltage of a signal carried on a Ring wire of the copper pair; a peak voltage of a signal carried on a Tip wire of the copper pair; and a peak voltage of a signal carried on a Ring wire of the copper pair.

11. The device of claim 1 and also comprising a power supply operative to supply electric power to active components of the device.

12. The device of claim 1 and also comprising:
an xDSL signal type detector operatively associated with said controller for enabling said controller to compute common-mode noise versus differential signal imbalance.

13. The device of claim 2 and also comprising:
an xDSL signal type detector operatively associated with said controller for enabling said controller to compute common-mode noise versus differential signal imbalance.

14. The device of claim 12 and wherein said xDSL detector is operative to provide at least one differential-mode component for enabling the controller to compute at least one peak voltage-to-RMS voltage ratio for analyzing common-mode noise versus differential signal imbalance.

15. The device of claim 1 and wherein said device corrects longitudinal balance of a copper pair carrying one of the following: unidirectional signals; and bi-directional signals.

16. A line balance correction device for correcting longitudinal balance of a copper pair, the device being adapted to be connected in parallel to the copper pair and to a local ground, the device comprising:
a controller; and
at least one current source for connecting to each wire of the copper pair, each said at least one current source being independently controlled by said controller for providing at least one cancellation signal for reducing at least one of the following: common-mode noise; and differential signal imbalance.

17. A line balance correction device for correcting longitudinal balance of a copper pair, the device being adapted to be connected in parallel to the copper pair and to a local ground, the device comprising:
a controller; and
at least one voltage detector operatively associated with said controller for enabling said controller to compute at least one of the following: a line imbalance; and common-mode noise versus differential signal imbalance.

18. A line balance correction device for correcting longitudinal balance of a copper pair, the device being adapted to be connected in parallel to the copper pair and to a local ground, the device comprising:
a controller;
at least one voltage detector operatively associated with said controller and operative to enable said controller to compute at least one of the following: a line imbalance; and common-mode noise versus differential signal imbalance;
a band-pass filter operatively associated with said at least one voltage detector, the band-pass filter being programmable throughout a frequency band of an xDSL transmission and operative to output band-limit signals to said at least one voltage detector;
at least one variable resistor for connecting to each wire of the copper pair, wherein the resistance of each said at least one variable resistor is independently controlled by said controller for matching, at least up to an acceptable resistance difference level, resistance of signals carried over a corresponding wire of the copper pair to the local ground;
at least one current source for connecting to each wire of the copper pair, each said at least one current source being independently controlled by said controller for providing at least one cancellation signal for reducing at least one of the following: common-mode noise; and differential signal imbalance; and
a power supply operative to supply electric power to active components of the device.

19. An xDSL transmission system comprising:
an xDSL Transceiver Unit central office (xTU-C);
an xDSL Transceiver Unit remote unit (xTU-R);
a copper pair operatively associating said xTU-C with said xTU-R; and
the device of claim 1.

20. An xDSL transmission system comprising:
an xDSL Transceiver Unit central office (xTU-C);
an xDSL Transceiver Unit remote unit (xTU-R);
a copper pair operatively associating said xTU-C with said xTU-R; and
the device of claim 16.

21. An xDSL transmission system comprising:
an xDSL central office transmission unit (xTU-C);
a remote xDSL transmission unit (xTU-R);
a copper pair operatively associating said xTU-C with said xTU-R; and
the device of claim 17.

22. A method for correcting longitudinal balance of a copper pair, the method comprising:
sensing resistance of each wire of said copper pair; and
independently controlling said resistance of each wire of said copper pair for matching, at least up to an acceptable resistance difference level, resistance of signals carried over a corresponding wire of the copper pair to a local ground.

23. A method for correcting longitudinal balance of a copper pair, the method comprising:
computing at least one of the following: common-mode noise on the copper pair; and differential signal imbalance on the copper pair; and
providing at least one cancellation signal for respectively reducing at least one of the following: said common-mode noise; and said differential signal imbalance.

24. A method for correcting longitudinal balance of a copper pair, the method comprising:
detecting, for each wire of said copper pair, at least one of the following: a RMS voltage; and a peak voltage; and
using at least one of said RMS voltage and said peak voltage to compute at least one of the following: a line imbalance; and common-mode noise versus differential signal imbalance.
